(19) United States
(12) Patent Application Publication
(10) Pub. No.: US 2016/0012550 A1
(43) Pub. Date: Jan. 14, 2016

(54) METHODS AND COMPUTER PROGRAM PRODUCTS FOR RECEIPT INFORMATION PROCESSING

(71) Applicant: My Loyalty Card LLC, South Lebanon, OH (US)

(72) Inventors: Todd Carbo, South Lebanon, OH (US); Casey Moser, Cincinnati, OH (US)

(73) Assignee: My Loyalty Card LLC, South Lebanon, OH (US)

(21) Appl. No.: 14/796,558

(22) Filed: Jul. 10, 2015

Related U.S. Application Data
(60) Provisional application No. 62/023,345, filed on Jul. 11, 2014.

(51) Int. Cl. G06Q 40/00; G06Q 10/10

(52) U.S. Cl. CPC G06Q 40/12; G06Q 10/107

(57) ABSTRACT

Methods and computer program products for automatically receiving and processing receipt information are disclosed. In one embodiment, a method of processing receipt information includes electronically receiving a receipt at a domain-specific e-mail address, wherein the domain-specific e-mail address is associated with an individual consumer, extracting receipt information from the receipt received at the domain-specific e-mail address, and preparing for display, in a graphical user interface on an electronic display, the receipt information associated with the individual consumer. Other types of information may also be received by e-mail and automatically processed and organized, such as marketing information, invoice information, and flight information. The processed information is organized and displayed in the graphical user interface.

### CROSS REFERENCE TO RELATED APPLICATIONS

This application claims the benefit under 35 U.S.C. §119(e) of U.S. Provisional Application No. 62/023,345, filed on Jul. 11, 2014, which is incorporated by reference herein in its entirety.

### BACKGROUND

1. Field

The present specification generally relates to electronic receipt information and, more particularly to the processing, organizing and display of electronic receipt, marketing, shipping, and other information in a graphical user interface.

2. Technical Background

For many years, consumers have been increasingly making purchases online, such as through websites or mobile device applications. Typically, the consumer makes the online purchase using an account registered with the retailer or as a guest. In either case, the consumer provides an e-mail address to the retailer. The retailer then sends an electronic receipt to the consumer via e-mail, which the consumer receives in his or her e-mail inbox. Additionally, brick-and-mortar retailers are also providing the option to send electronic receipts to consumers rather than printing a hard copy of the receipt.

However, receiving many e-mail receipts from many different retailers into a personal e-mail inbox results in the receipts being lost amongst potentially thousands or tens of thousands of e-mails within the inbox making it very difficult to locate the receipts. Further, providing an e-mail address to a retailer often results in a plethora of marketing e-mails from the retailer, third parties to which the retailer provided the e-mail address, or both, which further makes it more difficult to locate receipts within an e-mail inbox.

Existing tools to manage electronic receipts often require the consumer to forward or otherwise provide the electronic receipts to a third party servicer that organizes the receipt information corresponding to the electronic receipts that it receives. However, putting the onus on the consumer to forward an electronic receipt for each transaction to the third party servicer has resulted in low adoption rates of the service because consumers may forget to forward the electronic receipt, may delay in forwarding the electronic receipt, or for other reasons.

Accordingly, a need exists for alternative methods and computer program products for receiving, organizing and displaying receipt information.

### SUMMARY

In one embodiment, a method of processing receipt information includes electronically receiving a receipt at a domain-specific e-mail address, wherein the domain-specific e-mail address is associated with an individual consumer, extracting receipt information from the receipt received at the domain-specific e-mail address, and preparing for display, in a graphical user interface on an electronic display, the receipt information associated with the individual consumer.

In another embodiment, a computer program product includes a non-transitory computer readable medium storing a set of computer readable instructions for processing receipt information that, when executed by one or more processors, causes the one or more processors to electronically receive a receipt at a domain-specific e-mail address, wherein the domain-specific e-mail address is associated with an individual consumer. The instructions further cause the one or more processors to extract receipt information from the receipt received at the domain-specific e-mail address, and prepare for display, in a graphical user interface on an electronic display, the receipt information associated with the individual consumer.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computing network for receiving and processing receipt information according to one or more embodiments shown and described herein;

FIG. 2 depicts a schematic illustration of the server computing device from FIG. 1, further illustrating hardware and software that may be utilized in receiving and processing receipt information, according to one or more embodiments shown and described herein;

FIG. 3 graphically depicts a workflow for receiving and processing receipt information according to one or more embodiments shown and described herein;

FIG. 4 depicts a schematic illustration of an example graphical user interface for displaying processed receipt information according to one or more embodiments shown and described herein; and

FIG. 5 depicts a schematic illustration of another example graphical user interface for displaying processed receipt information according to one or more embodiments shown and described herein.

### DETAILED DESCRIPTION

Embodiments described herein are directed to methods and computer program products for receiving, organizing and displaying receipt information to consumers. Particularly, embodiments described herein utilize a centralized, system-specific e-mail domain to receive and process electronic receipts and marketing material from retailers. Embodiments extract receipt information from the received electronic receipts and organize and display it in an easy-to-read graphical user interface that is viewable on a display of an electronic device, such as a personal computer, tablet, smart phone, and the like. Consumer users who enroll in the system receive a domain-specific e-mail address that they provide to retailers for online and brick-and-mortar transactions.

As used herein, the term “domain-specific e-mail address” means an e-mail address associated with a specific e-mail domain that is controlled, either directly or indirectly through a service provider, by the entity performing the electronic receipt collection, processing and display. Further, e-mails received from the domain-specific e-mail address are accessible to the entity performing the electronic receipt collection, processing and display. As an example and not a limitation, if the entity that is providing the receipt information processing, organization and display service is named “Filtroe,” a system-specific domain may be entitled “filtroe,” and a domain-specific e-mail address issued to consumer Jane Doe may be “jane.doe@filtroe.com.” All e-mails sent to the system (i.e., the system operated by the entity performing the electronic receipt collection, processing and display) from “jane.doe@filtroe.com” are accessible to Filtroe such that the e-mails may be automatically processed.

When the consumer provides his or her domain-specific e-mail address to the retailer, the retailer sends electronic receipts corresponding with transactions between the consumer and the retailer to the domain-specific e-mail address. The receipt processing entity, because it operates or otherwise controls the system-specific domain of the domain-specific e-mail address, receives the electronic receipts from the retailer. The receipt processing entity may then extract, organize and display the receipt information for the consumer in a graphical user interface. Because the receipts are sent to the domain-specific e-mail address and automatically received by the receipt processing entity, the consumer no longer has to remember to forward the electronic receipts to a third party processor, and the receipt information is automatically processed and organized without requiring consumer action other than signing up for the service and providing the domain-specific e-mail address to retailers. Accordingly, the system helps consumer members track all of their receipts for purchases in one location. The data has many uses for the consumer, such as, but not limited to, budgeting, knowing what he or she spends when and where, and the like.

As described in more detail below, marketing information may also be similarly received, processed and displayed to the consumer. Accordingly, embodiments may assist retailers with marketing campaigns by sending relevant information to a consumer member's dashboard (i.e., a graphical user interface) in a summary format.

Various embodiments for methods and computer program products for processing receipt and marketing information are described in detail below.

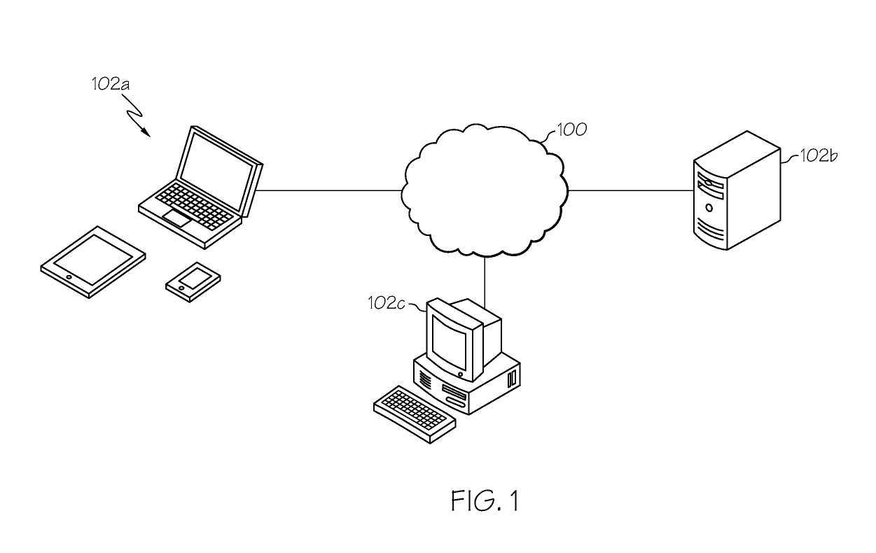

Referring now to the drawings, FIG. 1 depicts an exemplary computing network, illustrating components for a system for processing receipt information, according to embodiments shown and described herein. As illustrated in FIG. 1, a computer network 100 may include a wide area network, such as the internet, a local area network (LAN), a mobile communications network, a public service telephone network (PSTN) and/or other network and may be configured to electronically connect a user computing device 102a, a server computing device 102b, and an administrator computing device 102c.

The user computing device 102a may be used by a consumer user to administer his or account and to view receipt and marketing information in a graphical user interface. The user computing device 102a may also be utilized to perform other user functions. Additionally, included in FIG. 1 is the administrator computing device 102c. In the event that the server computing device 102b requires oversight, updating, or correction, the administrator computing device 102c may be configured to provide the desired oversight, updating, and/or correction.

It should be understood that while the user computing device 102a and the administrator computing device 102c are depicted as personal computers and the server computing device 102b is depicted as a server, these are non-limiting examples. More specifically, in some embodiments any type of computing device (e.g. mobile computing device, personal computer, server, etc.) may be utilized for any of these components. Additionally, while each of these computing devices is illustrated in FIG. 1 as a single piece of hardware, this is also a non-limiting example. More specifically, each of the user computing device 102a, server computing device 102b, and administrator computing device 102c may represent a plurality of computers, servers, databases, and the like.

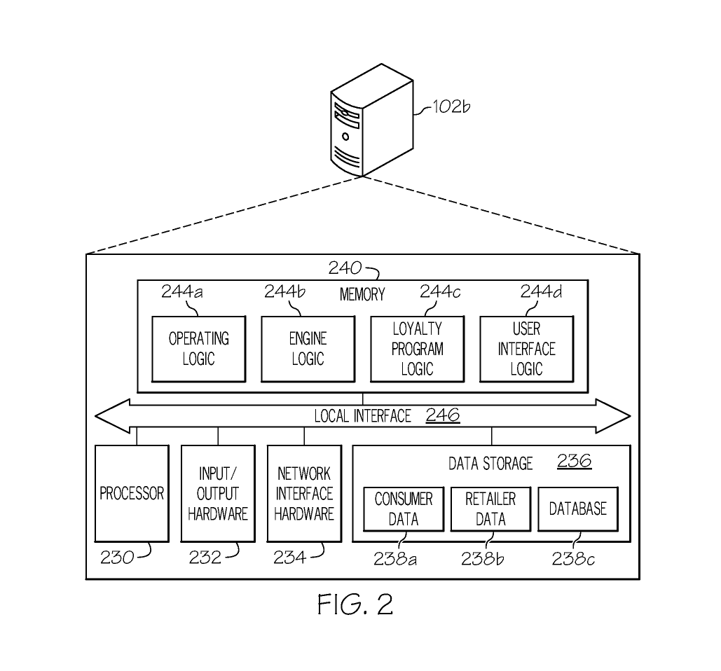

FIG. 2 depicts the server computing device 102b, from FIG. 1, further illustrating a system for semantically pairing document and/or a non-transitory computer readable medium for processing receipt information embodied as hardware, software, and/or firmware, according to embodiments shown and described herein. While in some embodiments, the server computing device 102b may be configured as a general purpose computer with the requisite hardware, software, and/or firmware, in some embodiments, that server computing device 102b may be configured as a special purpose computer designed specifically for performing the functionality described herein. Further, as stated above, the server computing device 102b may be configured as a plurality of computing devices rather than a single computing device.

As also illustrated in FIG. 2, the server computing device 102b may include a one or more processors 230, input/output hardware 232, network interface hardware 234, one or more data storage components 236 (which stores consumer member data 238a, retailer member data 238b, and a database 238c storing receipt information), and one or more memory components 240. The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store, as non-limiting examples, operating logic 244a, engine logic 244b, loyalty program logic 244c, and user interface logic 244d (each of which may be embodied as a computer program, firmware, or hardware, as an example). A local interface 246 is also included in FIG. 2 and may be implemented as a bus or other interface to facilitate communication among the components of the server computing device 102b.

The one or more processors 230 may include any processing component configured to receive and execute instructions (such as from the data storage component 236 and/or memory component 240). The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, wireless fidelity (Wi-Fi) card, WiMax card, cellular communications hardware, and/or other hardware for communicating with other networks and/or devices.

It should be understood that the one or more data storage components 236 may reside local to and/or remote from the server computing device 102b and may be configured to store one or more pieces of data for access by the server computing device 102b and/or other components. As illustrated in FIG. 2, the data storage component 236 may store consumer member data 238a, which may include consumer member account information, such as login information, domain-specific e-mail address, contact information, preferences, and the like. Similarly, retailer member data 238b may be stored by the data storage component 236 and may include information relating to retailers, such as retailer account information, preferences, and the like. A database 238 storing and organizing receipt and marketing information associated with the consumer members is also stored in the data storage component 236.

Included in the one or more memory components 240 are the operating logic 244a, the engine logic 244b, the loyalty program logic 244c, and the user interface logic 244d. The operating logic 244a may include an operating system and/or other software for managing components of the server computing device 102b. The engine logic 244b may be configured to receive e-mails received at domain-specific e-mail addresses or other sources, automatically determine electronic receipts, and extract receipt information from the electronic receipts. The engine may also be configured to automatically determine marketing e-mails and extract marketing information from the marketing e-mails. The loyalty program logic 244c is configured to receive and process the marketing information according to the preferences of the consumer member for presentation by the user interface logic 244d. The loyalty program logic 244 may also perform the marketing extraction from the marketing e-mails rather than the engine logic 244b. The user interface logic is configured to generate, or otherwise facilitate display of, a graphical user interface that presents receipt information and/or marketing information to a consumer user on an electronic display. It should be understood that, in some embodiments, such as where the user accesses the receipt and/or marketing information by way of a local application, at least some portions of the graphical user interface will be generated locally by logic operating on the user computing device 102a.

It should be understood that the components illustrated in FIG. 2 are merely exemplary and are not intended to limit the scope of this disclosure. More specifically, while the components in FIG. 2 are illustrated as residing within the server computing device 102b, this is a non-limiting example. In some embodiments, one or more of the components may reside external to the server computing device 102b. Similarly, while FIG. 2 is directed to the server computing device 102b, other components such as the user computing device 102a and the administrator computing device 102c may include similar hardware, software, and/or firmware. Further, the functionalities described herein may be implemented in more or fewer logic components provided on more than one computing device than as shown in FIG. 2.

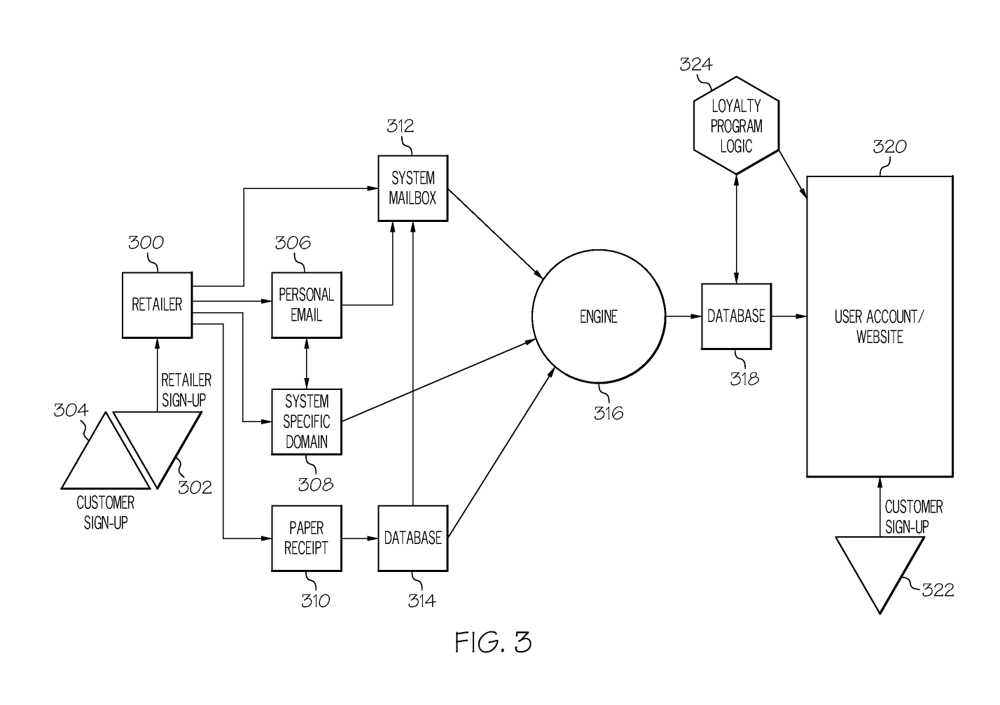

Referring now to FIG. 3, a flowchart illustrating functionality of the logic described above with respect to FIG. 2 for receiving, organizing, and processing receipt and marketing information for display to consumer users is graphically illustrated. The flowchart of FIG. 3 graphically illustrates an example workflow from where consumers and retailers sign up for the service (left side of the flowchart) to where the information is displayed in a graphical user interface (right side of the flowchart). As noted above, the embodiments described herein enable creation of a system-specific e-mail domain to receive e-mails directly from retailers to assist consumer members in tracking purchases and marketing information. Embodiments summarize received e-mails and places relevant contents in a graphical user interface for consumer and retail members.

The first step is for a consumer member to sign up for an account. The consumer member may sign up for an account while at a retailer member (block 304) or directly from a website or mobile device application (block 322). For example, the retailer 300 may have signed up as a retail member of the system (e.g., at block 302) such that it may send marketing materials through the system and also allow consumers to sign up for an account from the retailer location.

Upon signing up for the service, the consumer receives a domain-specific e-mail address. The consumer may also provide biographic information, as well as set preferences, such as what types of information he or she wishes to have extracted from electronic receipts and how he or she wishes for the information to be displayed in the graphical user interface.

The consumer completes a transaction at the retailer 300, either online or at a brick-and-mortar store. The consumer provides the retailer 300 with his or her domain-specific e-mail address, and indicates a preference for an electronic receipt to be sent to the domain-specific e-mail address. The retailer 300 sends the electronic receipt via e-mail to the domain-specific e-mail address associated with the consumer's account and/or with the particular transaction, where it is received at a system-specific domain 308. E-mails received at the system-specific domain 308 are automatically accessible to the engine 316, which accesses the e-mails to extract receipt information from the electronic receipts provided in the e-mails. Processing receipt information by the engine 316 is described in more detail below.

Additionally, registered consumers may prefer for e-mails received at their domain-specific e-mail addresses be forwarded to their respective personal e-mail addresses, as illustrated in FIG. 3.

Accordingly, the consumer may provide his or her domain-specific e-mail address to a plurality of retailers such that electronic receipts for each transaction between the consumer and the plurality of retailers is automatically provided to the engine 316 for processing without additional steps required by the consumer. For example, the consumer may set his or her domain-specific e-mail address as the e-mail address associated with an account of an on-line retailer such that electronic receipts from the online retailer are automatically sent to the receipt processing system. The consumer may also audibly tell a clerk at a retailer to send the electronic receipt to his or her domain-specific e-mail address.

Receipt information may also be received by the system in other ways. The consumer may prefer to have electronic receipts sent to his or her personal e-mail address 306 rather than the domain-specific e-mail address in some cases. The consumer, desiring for receipt information contained in an e-mail sent to the personal e-mail address 306, will then forward the e-mail from the personal e-mail account to a system mailbox 312. The engine 316 has authorization to access and analyze all e-mails sent to the system mailbox 312. The consumer may link his or her personal e-mail address with his or her system account. For example, the engine 316 may compare a personal e-mail address associated with an e-mail received at the system mailbox 312 to a list of personal e-mail addresses associated with registered consumers. When a personal e-mail address is identified as being associated with a registered consumer, the engine 316 accesses the e-mail and scans its content for receipt information, as described in more detail below.

As another example, a retailer 300 may only provide paper receipts 310, or the consumer may desire for the receipt to be printed as a paper receipt 310 rather than receive an electronic receipt. In this case, the consumer may generate image data 314 representing the paper receipt 310. The image data 314 may be generated by a digital photograph of the paper receipt 310, by an opto-electrical scan of the paper receipt 310, or by any other means. In one non-limiting example, the consumer takes a digital picture of the paper receipt 310 with his or her smart phone using a mobile application developed by the entity performing the receipt information processing. After taking the digital picture of the paper receipt 310, the mobile application, using network hardware of the smart phone, automatically sends the digital picture (i.e., the image data 314) of the paper receipt 310 to the engine 316 where the receipt information is automatically extracted, as described in more detail below.

As shown in FIG. 3, it is also possible for a retailer 300 to send electronic receipts to the system mailbox 312 in addition to, or in lieu of, the domain-specific e-mail address and/or the personal e-mail address. For example, where the retailer 300 is a retail member of the system, the retailer 300 may send the electronic receipt in an e-mail comprising consumer identifying information along so that the engine may determine which registered consumer is associated with the e-mail.

As stated above, the engine 316 (e.g., provided by engine logic 244b described above) is configured to automatically determine whether or not an e-mail received at either the system-specific domain 308 or the system mailbox 312 is or contains an electronic receipt. For example, many non-receipt e-mails may be received at the system-specific domain 308 or the system mailbox 312. The engine 316 is also automatically configured to extract receipt information from e-mails received either at the system-specific domain 308 or the system mailbox 312. The receipt information may include information such as, but not limited to, merchant name, merchant address, date and time of transaction, articles purchased, price per article purchased, total price of purchase, tax amount, shipping costs, and category of each article purchased. The receipt information may be both detected and extracted by any known or yet-to-be-developed text detection and extraction techniques.

Once the receipt information is extracted from the electronic receipt/e-mail, it is populated into relevant fields of a database(s). Receipt information associated with a plurality of registered consumers is therefore organized and stored in the database 318 for retrieval and display on a graphical user interface 320.

In some embodiments, the engine 316 is also configured to detect marketing e-mails sent to addresses of the system-specific domain 308 and/or the system mailbox 312. For example, retailers may, in addition to sending electronic receipts, may also send e-mails regarding certain promotions that the retailer is offering, such as a sale or issuance of coupons. The engine 316 may extract this marketing information from the marketing e-mails and store it in the database 318, where it may then be formatted for display in the graphical user interface 320. Retailer members of the system may also send marketing or promotional information to consumer members in a predetermined format that easy for the engine 316 to recognize and extract for population into the database.

Still referring to FIG. 3, in some embodiments, a loyalty engine is also provided, which may be implemented using the loyalty program logic 244c described above. The loyalty engine 324 uses information in the database to assist retailer members in operating a loyalty program. For example, depending on settings set by the retailer, the loyalty engine 324 may run one or more loyalty programs based on traffic (e.g., feet in the door), purchases, products, or money spent. As a non-limiting example, one loyalty program may provide a consumer with a $10 gift card for each $100 spent with the retailer. These loyalty programs may be implemented using the loyalty engine 324 as well as the data regarding each consumer that is stored in the database.

The engine 316 and/or the loyalty engine 324 may also be configured to analyze purchases made by the consumer member to automatically provide shopping lists for the user. Such as shopping list will allow a consumer user to track their home inventory for food, paper goods, and the like.

Consumer members access their receipt and marketing information at the graphical user interface 320, which is also referred to herein as a consumer member dashboard. Similarly, retailer members may access relevant information retarding their accounts, such as electronic receipts sent to its customers, in a graphical user interface 320 implemented as a retailer member dashboard. The various graphical user interface 320 are displayed on an electronic display, such as a computer monitor, a television, or a screen of a smart phone or tablet, for example. The graphical user interface 320 may be displayed as a website, or as a screen of an application, such as a mobile device application.

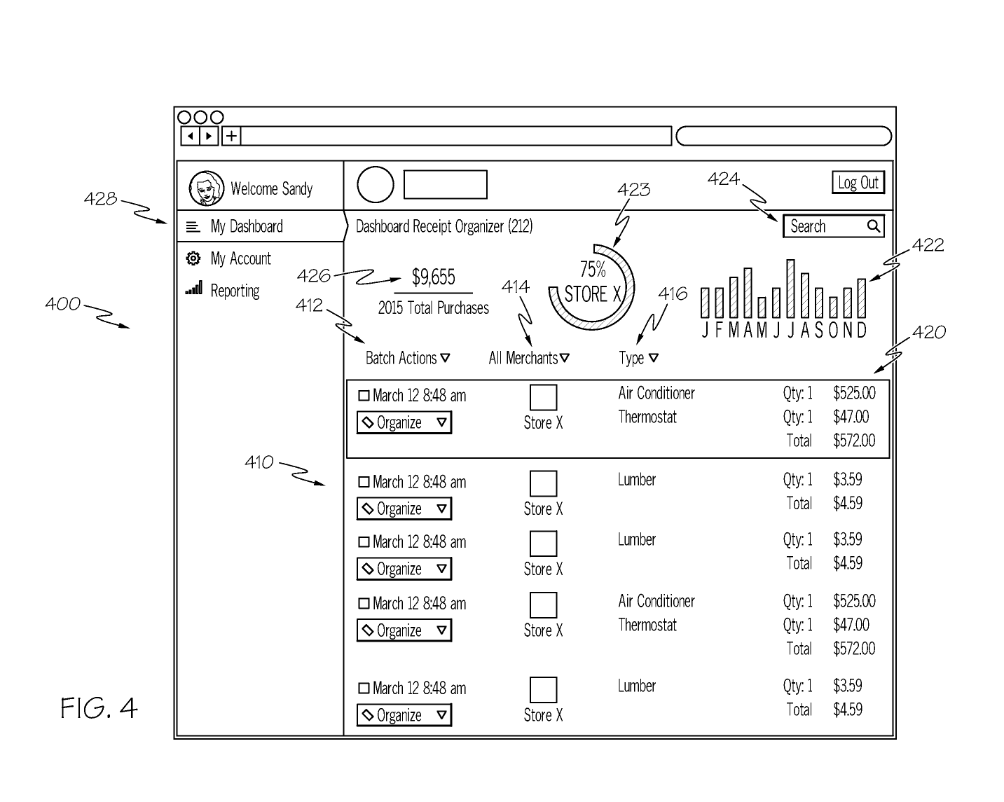

Referring now to FIG. 4, an example, non-limiting webpage 400 functioning as a graphical user interface providing a consumer member dashboard is schematically illustrated. It should be understood that the graphical user interface shown in FIG. 4 may also be implemented on a mobile device. The webpage 400 includes a receipt information area 410 for displaying receipt information extracted from electronic receipts. The receipt information area 410 may be organized according to consumer member preference. In the illustrated embodiment, the receipt information area 410 includes an actions column 412, a merchant column 414, an article/service type column 416, a quantity column 418, and a price column 420. It should be understood that more or fewer columns may be provided in the receipt information area 410. Additional information that may be displayed includes shipping information, warranty information, and the like. The example webpage 400 further includes a navigation panel 428 that allows a user to navigate through out the website or application, such as go to an account page to view/change settings, go to a reporting page to view/generate various financial transaction or spending reports, or any other pages.

The example webpage 400 also includes a graph 422 illustrating historical spending data, a graphic 423 depicting a percentage of a budget set by the user, and a graphic 426 representing a total amount the consumer has spent for a period of time (e.g., for a calendar year). It should be understood that other types of spending data may also be presented in the webpage 400.

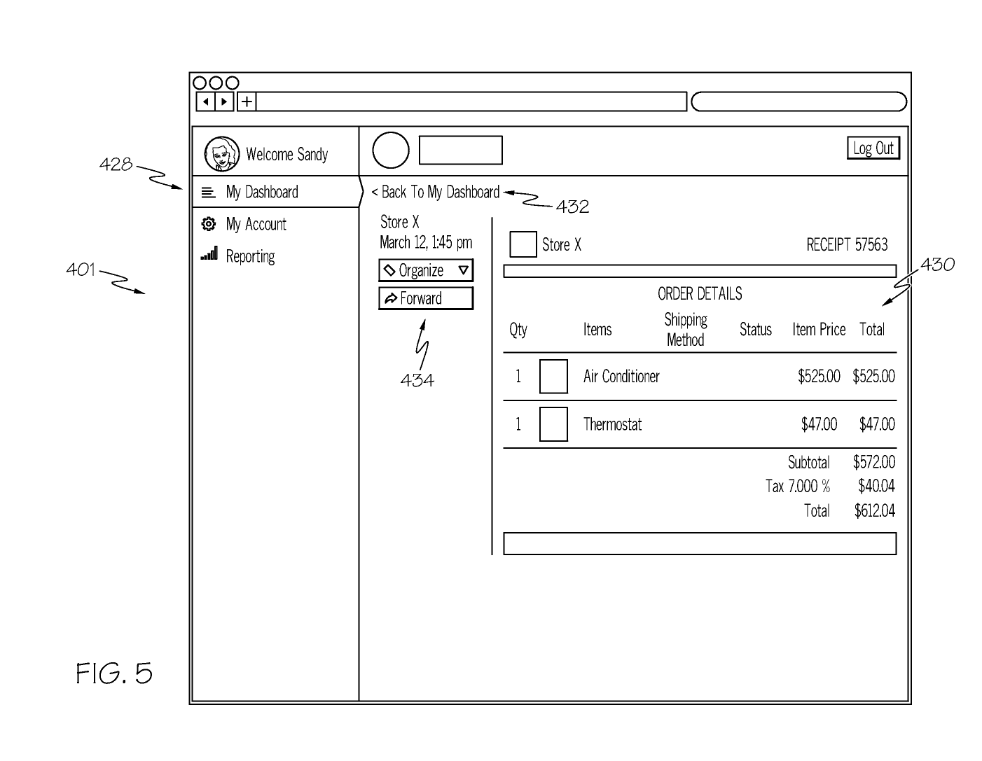

Rows of the receipt information area 410 represent receipt information regarding an individual transaction between the consumer member and a retailer. Clicking or otherwise selecting a row causes a new webpage 401 (or screen of an application) to be displayed on the electronic display, as shown in FIG. 5. The webpage 401 shown in FIG. 5 includes an order detail summary 430 that displays particulars of the receipt information relating to the transaction. In some embodiments, the webpage 401 displays the actual electronic receipt received from the retailer 300. In other embodiments, the order detail summary 430 is a formatted version of the electronic receipt.

The example webpage 401 further includes control buttons 434 that allow a user to perform various organizing tasks, such as organize/sort information according to preferences, as well as forward the selected electronic receipt by e-mail. As an example and not a limitation, a user may be able to forward the receipt to friend or family member so that they may return a gift. As another non-limiting example, a user may be able to sort information by purchase method (e.g., cash, credit card), stores most frequently visited, large purchases, etc (e.g., by use of the “organize” button illustrated in FIGS. 4 and 5. It should be understood that other control buttons enabling additional functions may also be provided.

Additional functionality may also be provided. For example, the engine may be configured to automatically detect billing or invoice e-mails. The billing or invoice e-mails may be analyzed by the engine 316 to extract relevant invoice information, store the relevant invoice information in the database 318, and display the formatted invoice information in the graphical user interface 320. The engine 316 may also be configured to automatically determine other types of e-mails received from the system mailbox 312 or the system-specific domain 308, such as flight information e-mails, shipping notifications, payment notifications, and the like. The information from these e-mails is extracted, categorized, stored in the database 318, and then displayed in the graphical user interface 320.

It should now be understood that the embodiments described herein may enable automatic receipt, processing, organizing and display of information, such as receipt information and marketing information. Embodiments utilize domain-specific e-mail addresses to receive electronic receipts from consumers and automatically process receipt information from the electronic receipts. By using domain-specific e-mail addresses, consumers using the system never have to remember to forward their electronic receipts to the system. By using a domain-specific e-mail addresses for purchases rather than a personal e-mail address, users will limit the amount of marketing materials and spam that is sent to their personal e-mail address. Further, embodiments organize all of the information that it receives and categorizes it in a dashboard-like graphical user interface.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of processing receipt information, the method comprising:
electronically receiving a receipt at a domain-specific e-mail address, wherein the domain-specific e-mail address is associated with an individual consumer;
extracting receipt information from the receipt received at the domain-specific e-mail address; and
preparing for display, in a graphical user interface on an electronic display, the receipt information associated with the individual consumer.

2. The method of claim 1, wherein the receipt is received from a retailer.

3. The method of claim 1, wherein the receipt is received from a personal e-mail address associated with the individual consumer.

4. The method of claim 1, further comprising:
receiving an additional receipt at a system mailbox;
extracting additional receipt information from the additional receipt; and
preparing for display, in the graphical user interface on the electronic display, the additional receipt information associated with the individual consumer.

5. The method of claim 4, wherein the additional receipt received at the system mailbox is received from a personal e-mail address associated with the individual consumer.

6. The method of claim 4, wherein the additional receipt received at the system mailbox is received from a retailer.

7. The method of claim 1, further comprising:
receiving image data representing a paper receipt;
extracting paper receipt information from the image data; and
preparing for display, in the graphical user interface on the electronic display, the paper receipt information associated with the individual consumer.

8. The method of claim 7, wherein the image data representing the paper receipt is received at a system mailbox.

9. The method of claim 1, further comprising extracting receipt information from a plurality of receipts associated with a plurality of transactions, and preparing for display, in the graphical user interface on the electronic display, a plurality of graphical representations of extracted information associated with the plurality of transactions.

10. A computer program product comprising:
a non-transitory computer readable medium storing a set of computer readable instructions for processing receipt information that, when executed by one or more processors, causes the one or more processors to:
electronically receive a receipt at a domain-specific e-mail address, wherein the domain-specific e-mail address is associated with an individual consumer;
extract receipt information from the receipt received at the domain-specific e-mail address; and
prepare for display, in a graphical user interface on an electronic display, the receipt information associated with the individual consumer.

11. The computer program product of claim 10, wherein the receipt is received from a retailer.

12. The computer program product of claim 10, wherein the receipt is received from a personal e-mail address associated with the individual consumer.

13. The computer program product of claim 10, wherein the set of computer readable instructions further cause the one or more processors to:
receive an additional receipt at a system mailbox;
extract additional receipt information from the additional receipt; and
prepare for display, in the graphical user interface on the electronic display, the additional receipt information associated with the individual consumer.

14. The computer program product of claim 13, wherein the additional receipt received at the system mailbox is received from a personal e-mail address associated with the individual consumer.

15. The computer program product of claim 13, wherein the additional receipt received at the system mailbox is received from a retailer.

16. The computer program product of claim 10, wherein the set of computer readable instructions further cause the one or more processors to:
receive image data representing a paper receipt;
extract paper receipt information from the image data; and
prepare for display, in the graphical user interface on the electronic display, the paper receipt information associated with the individual consumer.

17. The computer program product of claim 16, wherein the image data representing the paper receipt is received at a system mailbox.

18. The computer program product of claim 10, wherein the set of computer readable instructions further cause the one or more processors to:
receive an additional receipt at a system mailbox;
extract additional receipt information from the additional receipt;
receive image data representing a paper receipt;
extract paper receipt information from the image data;
prepare for display, in the graphical user interface on the electronic display, the additional receipt information associated with the individual consumer; and
prepare for display, in the graphical user interface on the electronic display, the paper receipt information associated with the individual consumer.

19. The computer program product of claim 18, wherein the additional receipt received at the system mailbox is received from a retailer or a personal e-mail address associated with the individual consumer.

20. The computer program product of claim 10, wherein the set of computer readable instructions further cause the one or more processors to extract receipt information from a plurality of receipts associated with a plurality of transactions, and prepare for display, in the graphical user interface on the electronic display, a plurality of graphical representations of extracted information associated with the plurality of transactions.
